(19) United States
(12) Patent Application Publication
(10) Pub. No.: US 2019/0304447 A1
(43) Pub. Date: Oct. 3, 2019

(54) ARTIFICIAL INTELLIGENCE ASSISTANT RECOMMENDATION SERVICE

(71) Applicant: Axwave, Inc., Menlo Park, CA (US)

(72) Inventors: Damian Scavo, Menlo Park, CA (US); Loris D'Acunto, Palo Alto, CA (US); Fernando Flores, New York, NY (US)

(21) Appl. No.: 16/147,113

(22) Filed: Sep. 28, 2018

Related U.S. Application Data
(60) Provisional application No. 62/566,174, filed on Sep. 29, 2017.
(60) Provisional application No. 62/566,142, filed on Sep. 29, 2017.

(51) Int. Cl. G10L 15/22; G06F 16/635; G10L 21/0272

(52) U.S. Cl. CPC G10L 15/22; G10L 2015/223; G10L 21/0272; G06F 16/637

(57) ABSTRACT

A computer-implemented method includes activating ACR (Automatic Content Recognition) functionalities through a voice command in an audio file received by a virtual assistant, processing the audio file to improve the audio file's quality, analyzing the processed audio file by querying a content recognition system using a media consumption profile associated with a user associated with the audio file, and providing a response to the voice command including a list of recommendations.

This application claims priority under 35 U.S.C. 119(a) to U.S. Provisional Application No. 62/566,174, filed on Sep. 29, 2017 and U.S. Provisional Application No. 62/566,142, filed on Sep. 29, 2017, the content of which is incorporated herein in its entirety for all purposes.

### BACKGROUND

### 1. Technical Field

An objective of the example implementations is provide a method of producing recommendations to a user in response to a voice command based on the voice command and the associated non-voice command audio data.

### 2. Related Art

Artificial intelligence assistants are limited by a command string that users must learn or teach the AI assistant through trial and error. In some cases, users may use a colloquial term, synonym, or pronoun that the artificial intelligence assistant is unable to process. For example, when a user asks an AI assistant, “What is this?” the AI assistant is unable to associate the pronoun “this” to process the command string without additional information. However, the audio stream combined with the command commonly includes additional sounds that can be used to process the command.

### SUMMARY

An objective of the example implementations is to provide a process that, in combining the features of a Virtual Assistant (powered by Artificial Intelligence features) and an Automatic Content Recognition (ACR) Engine based on audio fingerprinting, can enrich the user experience by providing recommendations on media content based on users' historical consumption and preferences. Different use cases are provided in the present document that use the AI Assistant-ACR Engine combination to save and process information about topics, genres, actors, writers, directors, etc. in exemplary implementations including television series, movies, or television programs.

A computer-implemented method is provided herein. Automatic Content Recognition (ACR) functionalities in an ACR engine are activated in response to a voice command in an audio file received by a virtual assistant. These ACR functionalities include one or more of capturing audio, sending fingerprints, or generating results. The audio file is then processed to improve the quality of the audio file. This processing separates the voice command from the non-voice command audio data in the audio file. The non-voice command audio data is then analyzed to identify one or more audio signals. A content recognition system is queried for each of the one or more audio signals, using a media consumption profile for a user associated with the audio file. In response to receiving a match between the one or more audio signals and the non-voice command audio data, the Virtual Assistant answers the user's query with a list of recommendations.

### BRIEF DESCRIPTION OF THE DRAWINGS

FIG. 1 illustrates the general infrastructure, according to an example implementation.

FIG. 2 illustrates a server-side flow diagram, according to an example implementation.

FIG. 3 shows a client-side flow diagram, according to an example implementation.

FIG. 4 illustrates an example process, according to an example implementation.

FIG. 5 illustrates an example environment, according to an example implementation.

FIG. 6 illustrates an example processor, according to an example implementation.

### DETAILED DESCRIPTION

The following detailed description provides further details of the figures and example implementations of the present specification. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Key aspects of the present application include activating Automatic Content Recognition (ACR) functionalities in an ACR engine in response to a voice command in an audio file received by a virtual assistant, processing the audio file, and presenting a list of recommendations to a user based on associated user data.

According to the present example implementation, one or more related art problems may be resolved. For example, but not by way of limitation, media content is generated and provided to a user via a device. An online application that is running on a device that is configured to receive an audio signal senses an audio input from the user. The audio input may be, but is not limited to a query from the user. In the query, the user may include a pronoun, but may exclude the noun associated with the query. In this situation, the example implementation will apply content ingestion and fingerprint extraction techniques, as well as data ingestion operations, to provide the ACR content database with the necessary information.

The ACR content database then applies one or more algorithms to determine the context and provide the information associated with the noun for which the pronoun was provided. While the foregoing description refers to a noun in the concept of a query in the English language, the present example implementations are not limited thereto, and other situations in which a portion of a query and other query structures may be substituted therefore without departing from the inventive scope. Further, queries may be performed in other languages with other structures, and similar results may be obtained in those languages by the example implementations.

Accordingly, the example implementations may permit a more natural and does user friendly approach to processing user queries, especially for those users who would typically use pronouns in their natural conversations and questions, and for which it would be unusual or awkward to use something other than the pronoun, such as “this” or the like, as explained in the further details below.

### Technical Discussion

An audio-based Automatic Content Recognition (ACR) runs on any device with a compatible operating system (i.e., smart speaker, smartphone, smart watch, smart TV, etc.). This technology uses the device's microphone to securely and privately collect media exposure in real time. The ACR Engine encrypts and compresses audio recorded by a microphone and either matches content on the device or sends a small “fingerprint” of data for servers to decipher. In both cases, a content database made out of previously ingested content fingerprints is required.

The database is populated with coded strings of binary digits (generated by a mathematical algorithm) that uniquely identifies original audio signals (called digital audio fingerprints). Fingerprints are the result of applying a cryptographic hash function to an input (in this case, audio signals). They are designed to be one-way functions, that is, functions which are infeasible to invert. Moreover, only a fraction of the audio is used to create the fingerprints. The combination of these two methodologies enables the possibility of storing digital fingerprints securely and in a privacy preserving manner, for example but not by way of limitation, without infringing copyright law.

A virtual assistant is a software agent that can perform tasks or services based on scheduling activities (e.g., pattern analysis, machine learning, etc.) for detecting triggers (e.g., a voice command, video analysis, sensor data, etc.). Virtual assistants may include various types of interfaces to interact with, for example:
Text (online chat), especially in an instant messaging application or other application
Voice, for example, with Amazon Alexa on the Amazon Echo device, or Siri on an iPhone
By taking and/or uploading images, as in the case of Samsung Bixby on the Samsung Galaxy S8

The Virtual Assistant—ACR Engine combination can receive input form hardware (e.g., a microphone), a file, or a data stream. As described herein is a service that provides improved functionality with voice-enabled assistants.

### Technical Details

As mentioned previously, an audio-based ACR engine can include a microphone in order to capture users' media exposure. A client-side ACR Engine technology is described that is compatible with the operating system and proprietary requirements that power the virtual assistant. For example, for an ACR engine to work on a device running Siri, it will have to be compatible with the correspondent iOS version as well as with the developer guidelines defined by Apple.

### Basic Functionality

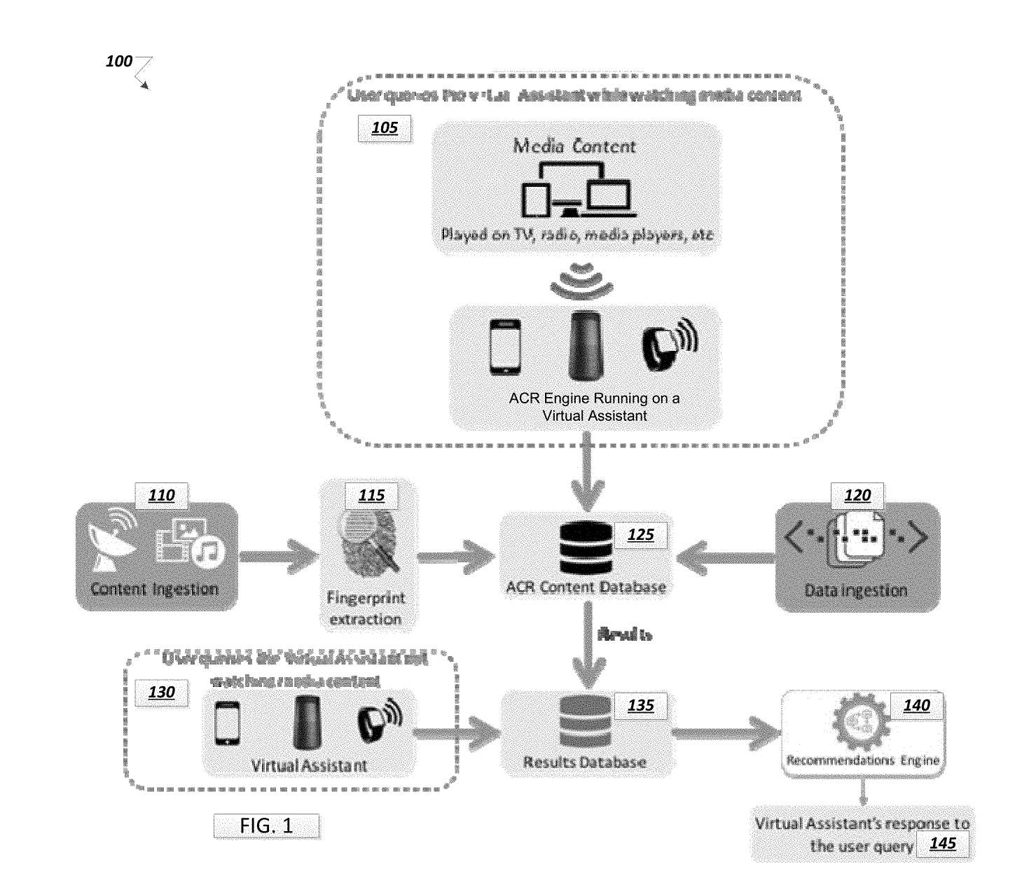

As shown in environment 100 in FIG. 1, after a user makes a query while watching media content at 105, the ACR engine running on a Virtual Assistant listens for content at 110, extracts fingerprints from that content at 115, and sends the fingerprints to the ACR content database 125. The ACR Engine also sends additional ingested data (e.g., background sound) 120 to the ACR content database 125.

The results are then sent to a results database 135, and the results are then sent to a recommendations engine 140. It is noted that the results database 135 may be distinct and separate and remotely located from the ACR content database 125 according to an example implementation. Accordingly, for user queries that are performed with respect to the virtual assistant when the user is not directly engaged with receiving the media content, the virtual assistant provides an output to the results database 135.

Finally, the Virtual Assistant takes the processed information and gives a response to the user's query at 145, based on an output of the results database 135, which is in turn based on an output of the virtual assistant 130, which is a user query from the virtual assistant that occurs when the user is not engaged with receiving the media content, as well as a result from the ACR content database 125, which is based on a user query that is associated with the user querying the virtual assistant while the user is engaged with receiving the media content at 105. In the case that the user queries the Virtual Assistant while not watching media content, shown at 130, the Virtual Assistant sends the content to the results database 135 and then to the recommendations engine 140 to get processed. The Virtual Assistant then takes the processed information and gives a response to the user's query at 145.

According to the example implementation, the user may be able to perform a query by the virtual assistant either while receiving the media content, or not while receiving the media content, and a recommendation engine 140 may provide a response to the user query 145. Accordingly, in the situations described herein where the user provides a pronoun, but a specific term is missing from the initial query, the query may be processed by the system based on a context aware approach that provides the context associated with the missing term, regardless of whether the user is watching the media content at the time of the query or not.

Thus, a user may have the opportunity to provide a more natural inquiry, and may not be forced to provide the natural inquiry at the time that media as being played. In other words, the user may pause the media make the query, if they wish to make a purchase without missing any of the media content based on what they saw in the media. For example, if a TV show is playing and an object is displayed in the media of the TV show that the user wishes to purchase, the user may pause or stop the TV show, and may then make a very natural query that may be missing a term, such as a noun or verb that is substituted by a pronoun, and the example implementation will determine the context of the missing term, and will in turn provide a response to the user query, such as by way of a recommendations engine.

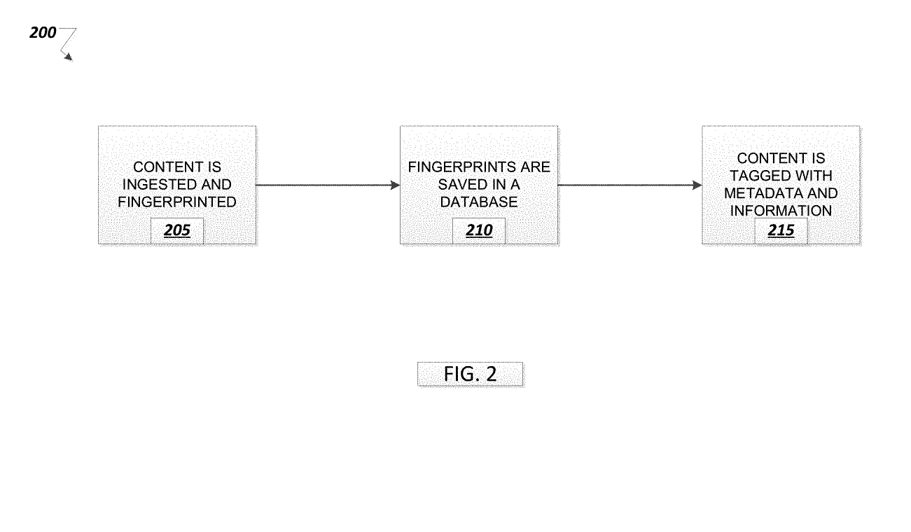

Server Side
As shown in environment 200 in FIG. 2, content (i.e., live television and radio feeds, movies, television series, television advertisements, music, videogames audio, and, in general, any content with audio) is ingested and fingerprinted at 205.
Fingerprints are saved in a database at 210.
Each content is tagged either manually or automatically with relevant metadata and information at 215. For example:
   Television program: airing time, topics, etc.
   Movies: actors, directors, writers
   Sports broadcasts: standings, related news, previous results, etc.
   Commercials: brand name, category of the product, information about the product (i.e., price, availability, nearby stores)

### Client Side

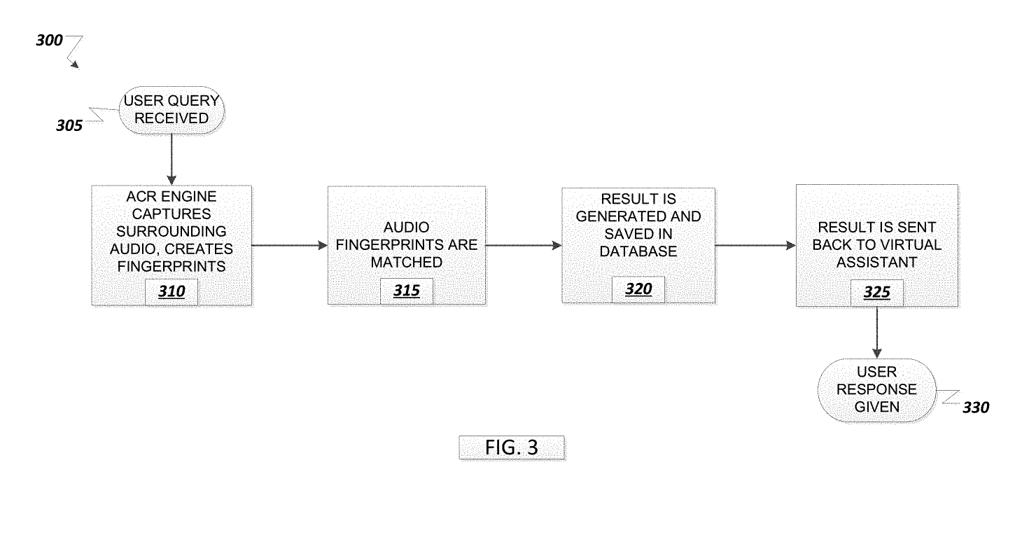

As shown in environment 300 in FIG. 3, in response to a user query received at 305, the ACR Engine captures surrounding audio and transforms it into digital fingerprints at 310.
The audio fingerprints are matched against a content database made out of other fingerprints at 315. This database can be hosted in the device or in a server.
   If the database is hosted on a server, the ACR Engine will use the Virtual Assistant's network capabilities to send them to such server for the matching process to take place.

### Results

Once the content has been matched (the fingerprints from the client-side have a correspondence on the database), a result is generated at 320.
Such result will include the metadata and information the content was assigned at the ingestion phase.
Results are saved on a database that feeds the recommendation engine at 320. These results are then sent back to the Virtual Assistant at 325 and a user response is given at 330.

### Recommendations Engine

User results are saved, creating a media consumption profile (following current applicable privacy regulation).
Data can be aggregated, creating different viewership groups.
The engine calculates affinity among different profiles, generating accurate recommendations based on previous consumption, ratings, and engagement.

### Implementation and Result Examples

1. A user is watching a TV program.
The user asks the Virtual Assistant, “I want to watch a similar program.”
   The Virtual Assistant activates the ACR functionalities (capturing audio, sending fingerprints, generating results) and makes a query to the recommendation engine. The recommendation engine then provides the Virtual Assistant with a list of content that match the user's preferences.

2. A user is not watching any content at the time.
The user asks the Virtual Assistant, “Give me movie recommendations.”
   The Virtual Assistant answers the user's query with a list of recommendations.

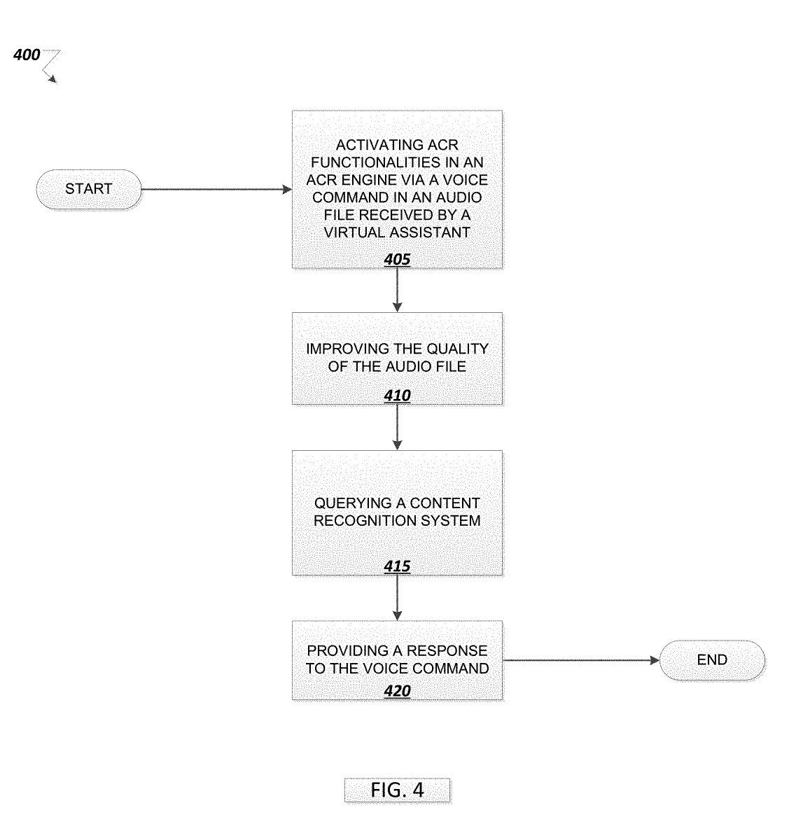

According to an example implementation of a use case, shown in environment 400 in FIG. 4, the following may occur with the present example implementations associated with the inventive concept:

A method comprising:
Receiving an audio file comprising a voice command at 405;
Improving the quality of the audio file at 410;
   Separating the voice command from remaining audio data in the audio file;
Analyzing the audio data to identify one or more audio signals;
   Querying a content recognition system for each of the one or more audio signals using a media consumption profile for the user associated with the audio file at 415;
   In response to receiving a match for the one or more audio signals,
   the Virtual Assistant answers the user's query with the list of recommendations at 420.

According to other implementations, the recommendation service can be integrated with using an Artificial Intelligence Assistant and an ACR Engine to provide users with enhanced information on the content being consumed including or in addition to purchasing options on the content being consumed.

For example, but not by way of limitation, a method comprising a Virtual Assistant activates the ACR functionalities (capturing audio, sending fingerprints, generating results); receives an audio file comprising a voice command; improves the quality of the audio file for processing including: separating the voice command from remaining audio data in the audio file; analyzing the audio data to identify one or more audio signals; querying a content recognition system for each of the one or more audio signals.

The result from the ACR Engine includes the context information (e.g., product and brand information such as “Nike Zoom 3”). The Virtual Assistant processes that information and in response to receiving a match for the one or more audio signals; locates supplemental information associated with the context information. For example but not by way of limitation, if the response includes a link to a store where the product is available, the Virtual Assistant answers the user's question by providing a purchasing option; sends a request to a third party resource or searches public and proprietary resources to pull extra data from other datasets (i.e., iTunes), and provides the user a response to the command string based on the context information associated with one of the environmental inputs. For example, the Virtual Assistant supplements pronouns with context information and extra data from third party resources and the Virtual Assistant then answers the user's question by providing a direct purchase option.

For example but not by way of limitation, the user asks the Virtual Assistant, “Which song is this?” and the Virtual Assistant activates the ACR functionalities (capturing audio, sending fingerprints, generating results). The result from the ACR Engine includes information about the song (i.e., “Wonderwall, by Oasis”), that the Assistant uses to answer the user's question. In another example, the user just asks the Virtual Assistant, “Buy this song,” and the Virtual Assistant activates the ACR functionalities (capturing audio, sending fingerprints, generating results). The results from the ACR engine includes information about the song (i.e., “Wonderwall by Oasis”). The Virtual Assistant processes that information and if the response includes a link to a store where the product is available, the Virtual Assistant answers the user's question by providing a purchase option or pulls extra data from other data sets (i.e. iTunes), and answers the user's question by providing a direct purchase option.

According to another example and an implementation of a use case, the following may occur with the present example implementations associated with the inventive concepts: the Virtual Assistant activates the ACR functionalities (capturing audio, sending fingerprints, generating results). The result from the ACR Engine includes the program topics (in this case, First World War). For example but not by way of limitation, A method comprising receiving an audio file comprising a voice command; improving the quality of the audio file; separating the voice command from remaining audio data in the audio file; analyzing the audio data in the audio file; analyzing the audio data to identify one or more audio signals; and querying a content recognition system for each of the one or more audio signals.

In response to receiving a match for the one or more audio signals, the ACR Engine will then query other available datasets based on the match for supplemental information, wherein results from the ACR Engine includes the program topics or extra information for related information. The results are then sent back to the Virtual Assistant, which is now ready to either share the results directly with the user or process and merge the results with any other available datasets. For example but not by way of limitation, when a user asks the Virtual Assistant, “What's this series and episode's ratings?” the Virtual Assistant activates the ACR functionalities (capturing audio, sending fingerprints, generating results). The result from the ACR Engine includes, among other things, the TV series and episode titles. The Virtual Assistant queries other available datasets (i.e., IMDB) and gets back to the user with the series and episode ratings.

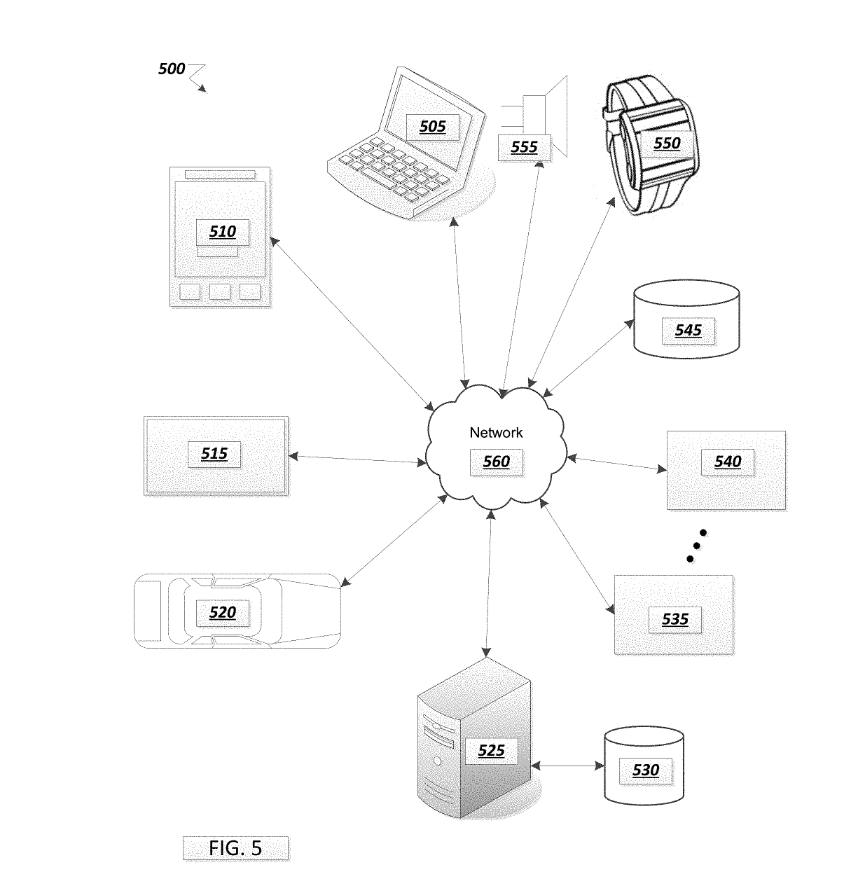

FIG. 5 shows an example environment suitable for some example implementations. Environment 500 includes devices 505-555, and each is communicatively connected to at least one other device via, for example, network 560 (e.g., by wired and/or wireless connections). Some devices may be communicatively connected to one or more storage devices 530 and 545. Devices 505-555 may include, but are not limited to, a computer 505 (e.g., a laptop computing device), a mobile device 510 (e.g., a smartphone or tablet), a television 515, a device associated with a vehicle 520, a server computer 525, computing devices 535-540, wearable technologies with processing power (e.g., smart watch) 550, smart speaker 555, and storage devices 530 and 545.

Example implementations may also relate to an apparatus for performing the operations herein. The apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-tangible media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

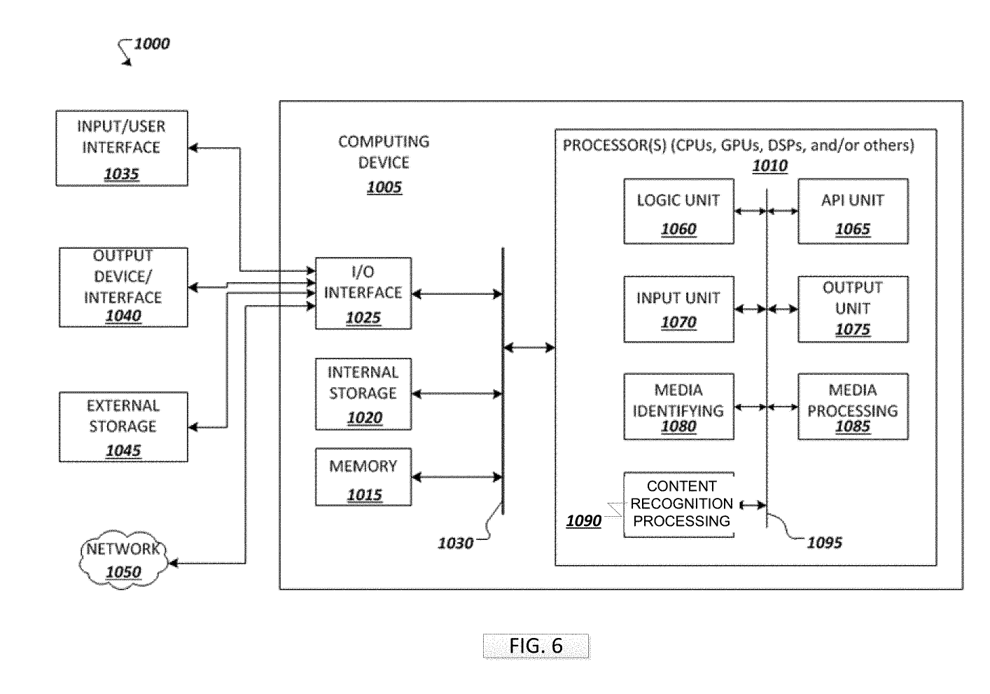

FIG. 6 shows an example computing environment with an example computing device suitable for implementing at least one example embodiment. Computing device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and I/O interface 1025, all of which can be coupled on a communication mechanism or bus 1030 for communicating information. Processors 1010 can be general purpose processors (CPUs) and/or special purpose processors (e.g., digital signal processors (DSPs), graphics processing units (GPUs), and others).

In some example embodiments, computing environment 1000 may include one or more devices used as analog-to-analog converters, digital-to-analog converters, and/or radio frequency handlers.

Computing device 1005 can be communicatively coupled to external storage 1045 and network 1050 for communicating with any number of networked components, devices, and systems, including one or more computing devices of the same or different configuration. Computing device 1005 or any connected computing device can be functioning as, providing services of, or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computing device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage) and other non-volatile storage or memory.

Computing device 1005 can be used to implement techniques, methods, applications, processes, or computer-executable instructions to implement at least one embodiment (e.g., a described embodiment). Computer-executable instructions can be retrieved from transitory media and stored on and retrieved from non-transitory media. The executable instructions can be originated from one or more of any programming, scripting, and machine languages (e.g., C, C++, Java, Visual Basic, Python, Perl, JavaScript, and others).

Processor(s) 1010 can execute under any operating system (OS) (not shown), in a native or virtual environment. To implement a described embodiment, one or more applications can be deployed that include logic unit 1060, application programming interface (API) unit 1065, input unit 1070, output unit 1075, media identifying unit 1080, and inter-communication mechanism 1095 for the different units to communicate with each other, with the OS, and with other applications (not shown). For example, media identifying unit 1080, media processing unit 1085, and content recognition processing unit 1090 may implement one or more processes described above. The described units and elements can be varied in design, function, configuration, or implementation and are not limited to the descriptions provided.

In some examples, logic unit 1060 may be configured to control the information flow among the units and direct the services provided by API unit 1065, input unit 1070, output unit 1075, media identifying unit 1080, media processing unit 1085, and media pre-processing unit to implement an embodiment described above. For example, the flow of one or more processes or implementations may be controlled by logic unit 1060 alone or in conjunction with API unit 1065.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices [e.g., central processing units (CPUs), processors, or controllers].

As is known in the art, the operations described above can be performed by hardware, software, or some combination of hardware and software. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or the functions can be spread out across a number of components in any number of ways. When performed by software, the methods may be executed by a processor, such as a general purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as known in the related art, text and mouse (i.e., pointing) actions may be detected and analyzed in video documents. Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A computer-implemented method for providing recommendations in response to a voice command based on the voice command and associated non-voice command audio data, the method comprising:
activating one or more Automatic Content Recognition (ACR) functionalities in an ACR engine in response to the voice command, the voice command being in an audio file received by a virtual assistant, wherein the functionalities include one or more of capturing audio, sending fingerprints, or generating results;
improving the quality of the received audio file by separating the voice command from the associated non-voice command audio data in the received audio file;
analyzing the non-voice command audio data to identify one or more audio signals by querying a content recognition system for each of the identified one or more audio signals using a media consumption profile for a user associated with the audio file;
providing a response to the voice command with a list of recommendations in response to receiving a match between the non-voice command audio data and the one or more audio signals; and
sending the response to the voice command to the virtual assistant.

2. The method of claim 1, wherein the fingerprints are generated by applying a cryptographic hash function to the audio file received by the virtual assistant,
wherein the generated fingerprints are stored in a database, the database being used to identify the one or more audio signals.

3. The method of claim 1, wherein the providing a response to the voice command comprises:
providing a purchase option associated with match between the non-voice command audio data and the one or more audio signals; and
sending a request to purchase to a third party,
wherein the purchase includes one or more of a song, a movie, a show or broadcasting, or a product.

4. The method of claim 3, wherein the response may further comprise providing a link to a store where the product is available.

5. A system comprising:
a memory;
a processor operatively coupled to the memory, the processor configured to:
activate one or more Automatic Content Recognition (ACR) functionalities in an ACR engine in response to a voice command, the voice command being in an audio file received by a virtual assistant, wherein the functionalities include one or more of capturing audio, sending fingerprints, or generating results;
improve the quality of the received audio file by separating the voice command from associated non-voice command audio data in the received audio file;
analyze the non-voice command audio data to identify one or more audio signals by querying a content recognition system for each of the identified one or more audio signals using a media consumption profile for a user associated with the audio file;
provide a response to the voice command with a list of recommendations in response to receiving a match between the non-voice command audio data and the one or more audio signals; and
send the response to the voice command to the virtual assistant.

6. The system of claim 5, wherein the fingerprints are generated by applying a cryptographic hash function to the audio file received by the virtual assistant,
wherein the generated fingerprints are stored in a database, the database being used to identify the one or more audio signals.

7. The system of claim 5, wherein the providing a response to the voice command comprises:
providing a purchase option associated with match between the non-voice command audio data and the one or more audio signals; and
sending a request to purchase to a third party,
wherein the purchase includes one or more of a song, a movie, a show or broadcasting, or a product.

8. The system of claim 7, wherein the response may further comprise providing a link to a store where the product is available.

9. A non-transitory computer readable medium, comprising instructions that when executed by a processor, the instructions to:
activate one or more Automatic Content Recognition (ACR) functionalities in an ACR engine in response to a voice command, the voice command being in an audio file received by a virtual assistant, wherein the functionalities include one or more of capturing audio, sending fingerprints, or generating results;
improve the quality of the received audio file by separating the voice command from associated non-voice command audio data in the received audio file;
analyze the non-voice command audio data to identify one or more audio signals by querying a content recognition system for each of the identified one or more audio signals using a media consumption profile for a user associated with the audio file;
provide a response to the voice command with a list of recommendations in response to receiving a match between the non-voice command audio data and the one or more audio signals; and
send the response to the voice command to the virtual assistant.

10. The non-transitory computer readable medium of claim 9, wherein the fingerprints are generated by applying a cryptographic hash function to the audio file received by the virtual assistant,
wherein the generated fingerprints are stored in a database, the database being used to identify the one or more audio signals.

11. The non-transitory computer readable medium of claim 9, wherein the providing a response to the voice command comprises:
providing a purchase option associated with match between the non-voice command audio data and the one or more audio signals; and
sending a request to purchase to a third party,
wherein the purchase includes one or more of a song, a movie, a show or broadcasting, or a product.

12. The non-transitory computer readable medium of claim 11, wherein the response may further comprise providing a link to a store where the product is available.
